(19) United States
(12) Patent Application Publication
(10) Pub. No.: US 2022/0186937 A1
(43) Pub. Date: Jun. 16, 2022

(54) DUAL COOKING APPLIANCE

(71) Applicant: Team International Group of America Inc., Miami Gardens, FL (US)

(72) Inventor: Uri Murad, Hollywood (US)

(21) Appl. No.: 17/679,528

(22) Filed: Feb. 24, 2022

Related U.S. Application Data
(63) Continuation-in-part of application No. 17/389,225, filed on Jul. 29, 2021.
Application No. 17/389,225 is a continuation-in-part of application No. 17/567,535, filed on Jan. 3, 2022.
Application No. 17/389,225 is a continuation-in-part of application No. 17/176,838, filed on Feb. 16, 2021, now Pat. No. 11,175,048.
Application No. 17/518,876 is a continuation-in-part of application No. 17/176,838, filed on Feb. 16, 2021, now Pat. No. 11,175,048.
(60) Provisional application No. 63/062,541, filed on Aug. 7, 2020.
(60) Provisional application No. 62/982,999, filed on Feb. 28, 2020.

(51) Int. Cl. F24C 7/08; G05D 23/19; F24C 15/16; F24C 15/32

(52) U.S. Cl. CPC F24C 7/085; F24C 15/325; F24C 15/166; G05D 23/1931

(57) ABSTRACT

A cooking appliance is adapted to perform either as a single large fan-forced convection oven capable of cooking a larger food, or as smaller independently-operable fan-forced convection ovens each capable of cooking smaller foods. Features of the cooking element arrangement provide faster, more efficient, and higher quality results regardless of the size and amount of food being cooked.

### FIELD OF THE INVENTION

The invention relates to cooking appliances. More specifically, it relates to countertop electric ovens, particularly having versatility to function as a single oven for cooking larger, or as one or more side-by-side independently-operable ovens for cooking smaller foods.

### BACKGROUND

Electric ovens are well-known and one common variety is the fan-forced convection oven. Fan-forced convection ovens include an air heater and a fan. The turbulence by the fan of the cooking air heated by the heater provides faster and more even cooking.

Air fryers are well-known and are an extreme form of fan-forced convection oven in which higher temperature air at a higher airflow rate is applied to oily food or food that has been coated in oil to brown the food in a manner that mimics the browning, crispiness, and flavor of deep frying, but without the mess, danger, and calories.

It is well known that fan-forced convection ovens are most efficient, cook faster, and cook food of a better quality when the oven's cooking cavity size and shape are proportional to the amount of food being cooked therein. When cooking a small portion of food in a large oven, heated airflow is hard to control the food is less evenly cooked and energy that would be best focused on cooking is wasted heating a mostly empty cooking chamber. Users who sometimes cook smaller portions and sometimes cook larger foods are therefore forced to purchase a large oven and a separate small oven individually to obtain optimal results, increasing cost, decreasing convenience. and requiring additional valuable storage and countertop space.

It is found through experience and experimentation that fan-forced convection ovens, which typically have only a single air heating element typically located in the top of the cooking chamber are prone to unheated hot air distribution. This is because, by the time the heated air reaches the underside of the food, its temperature has dropped. While the drop is small, it is not insignificant, as it results in the top surfaces of the cooked food being more cooked, crispier, and more browned than the bottom surfaces.

There exists the need to provide, and such may be an object of the invention, an apparatus which can function as a single oven for cooking larger foods, or as one or more adjacent independently-operable ovens for cooking smaller foods.

There exists the need to provide, and such may be an additional object of the invention, such an apparatus which can be converted between these functions quickly and simply.

There exists the need to provide, and such may be an additional object of the invention, for such an apparatus to function as a more effective and efficient fan-forced convection oven.

There exists the need to provide, and such may be an additional object of the invention, for such an apparatus to cook food evenly, quickly, and efficiently regardless of the size or amount of the food portion.

There exists the need to provide, and such may be an additional object of the invention, such an apparatus with is adapted to recognize which of these functions it is arranged to perform for the desired cooking requirement and to operate accordingly.

Further needs and objects of the invention will become apparent upon a review of the following disclosure of an exemplary embodiment.

### SUMMARY OF THE INVENTION

The invention may be embodied in or practiced using a cooking appliance which can selectively perform as a larger fan-forced convection oven for cooking larger foods, or as a plurality of smaller independently-operable fan-forced convection ovens for cooking a plurality of smaller foods.

The invention may be embodied in or practiced using a cooking appliance including; a housing defining a primary cooking cavity, a plurality of cooking elements, the plurality of access doors, and the plurality less one of user-installable and removable separation panels. The separation panels may be adapted to separate portions of the primary cooking cavity into a plurality of secondary cooking cavities, each including one or more of the cooking elements and each accessible through one of the access doors. The cooking elements may each include an air heating element and a fan for turbulizing the air heated thereby, and a controller for operation thereof.

The appliance may include means to recognize if and which of the separation panels are in place, and to communicate that one or more of the controllers which may control functions of the associated cooking elements including, but not limited to, one or more of temperature, heating wattage, cooking time, and fan speed. The functions of each cooking element may be controlled independently of the others.

The appliance may include means to recognize when no separator panels are in use, and to then synchronize the functions of all controllers so that the appliance operates as a single larger fan-forced convection oven employing all cooking elements in equal function and the primary cooking cavity. The synchronized controllers may control functions of the cooking elements as a single primary cooking element of the primary cooking cavity including, but not limited to, one or more of temperature, heating wattage, cooking time, and fan speed.

The appliance may be adapted to allow operation of all independently operated controllers such that the total wattage does not exceed a maximum wattage and to allow operation of the synchronized controllers such that the wattage is the maximum wattage

The access doors may be adapted for independent operation so that only one of the cooking cavities may be and needs to be opened during insertion or removal of food to be or having been cooked therein.

Further features and aspects of the invention are disclosed with more specificity in the Description and Drawings provided herein and showing exemplary embodiments of the invention.

### BRIEF DESCRIPTION OF THE DRAWINGS

Exemplary embodiments of fan-forced convection ovens in accordance with or useful in practicing the invention are shown in the accompanying Drawings, of which;

FIG. 1 is a perspective view of a first oven;

FIG. 2 is a front view of the oven of FIG. 1 in its closed state;

FIG. 3 is a side cross-sectional view of the oven of FIG. 1 taken at line 3-3 of FIG. 2;

FIG. 4 is a top view of the oven of FIG. 1 in its closed state;

FIG. 5 is a front cross-sectional view of the oven of FIG. 1 taken at line 5-5 of FIG. 4;

FIG. 6 is a side view of the oven of FIG. 1;

FIG. 7 is a rear view of the oven of FIG. 1;

FIG. 8 is an exploded view of the oven of FIG. 1;

FIG. 9 is a partial exploded view of the oven of FIG. 1;

FIG. 10A is a top view of the oven of FIG. 1 with its left door opened;

FIG. 10B is a top view of the oven of FIG. 1 with its right door opened;

FIG. 10C is a top view of the oven of FIG. 1 with both doors opened;

FIG. 11 is a perspective view of a second oven;

FIG. 12 is a front cross-sectional view of the oven of FIG. 11 taken at line 12-12 of FIG. 11;

FIG. 13 is a side cross-sectional view of a third oven;

FIG. 14 is a front cross-sectional view of the oven of FIG. 13 taken at line 14-14 of FIG. 13; and

FIG. 15 is a graph of a voltage cycling arrangement for the heating elements of the embodiments of FIG. 1 or 13.

### DESCRIPTION OF AN EXEMPLARY EMBODIMENT

The disclosures of related U.S. Provisional Application No. 62/982,999 filed on 28 Feb. 2020 and 63/062,541 filed on 7 Aug. 2020, co-pending U.S. Utility patent application Ser. No. 17/389,225 filed on 29 Jul. 2021, Ser. No. 17/567,535 filed on 3 Jan. 2022, and Ser. No. 17/518,876 filed on 4 Nov. 2021, and U.S. Pat. No. 11,175,048 issued on 16 Nov. 2021 are all incorporated herein by reference in their entireties and thereby form part of this Specification.

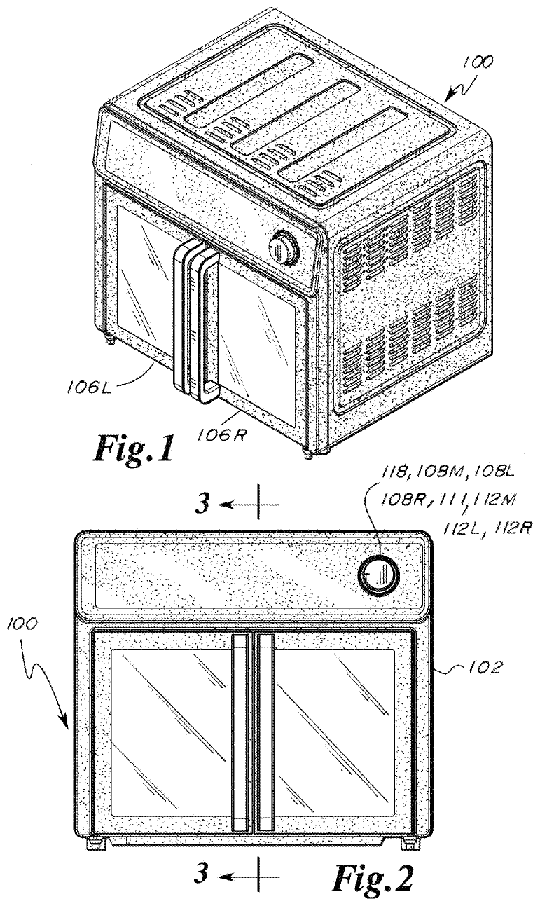

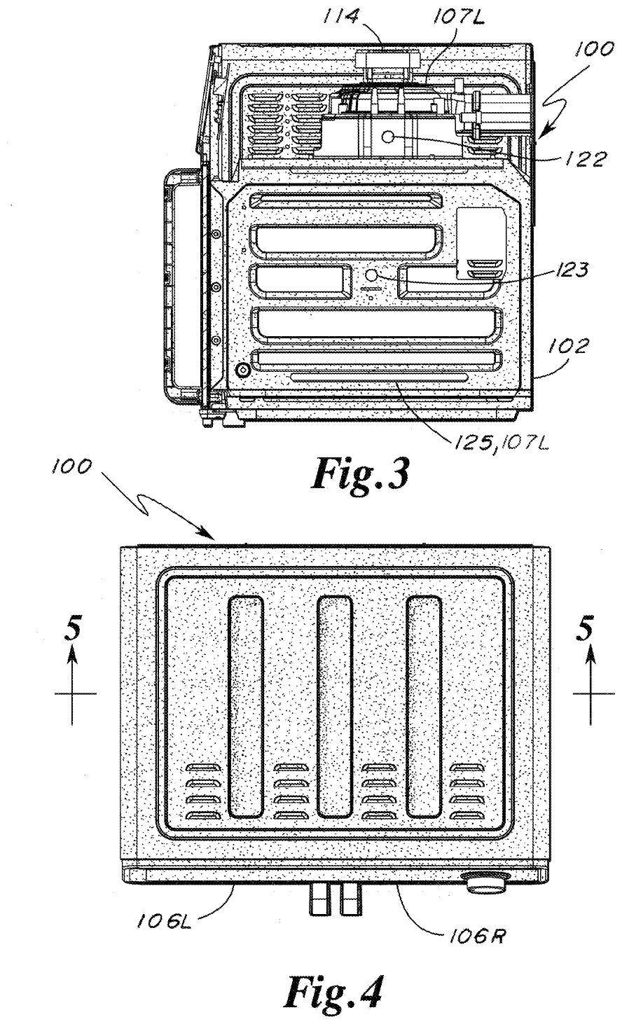

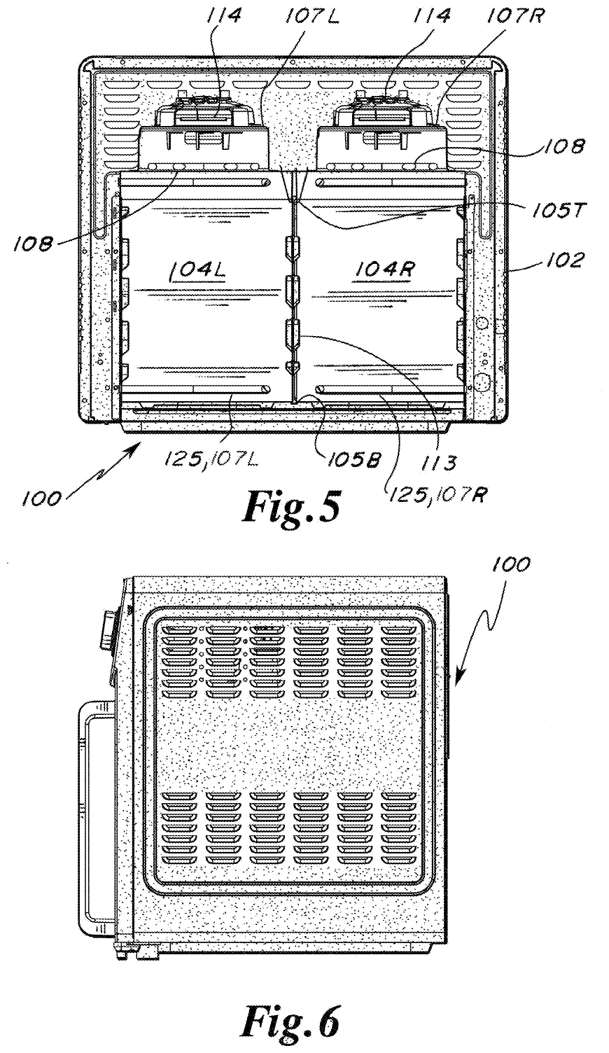

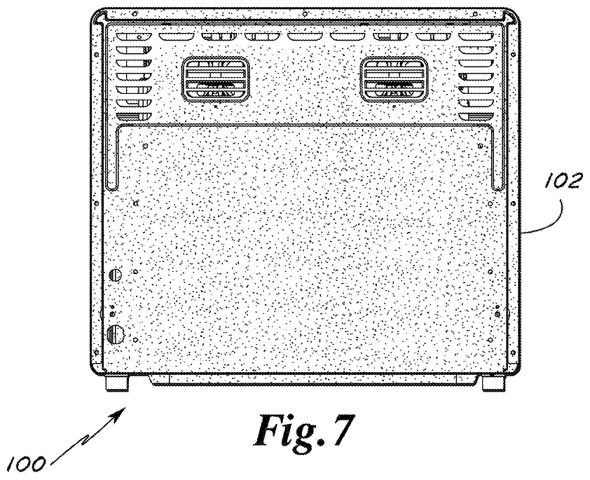

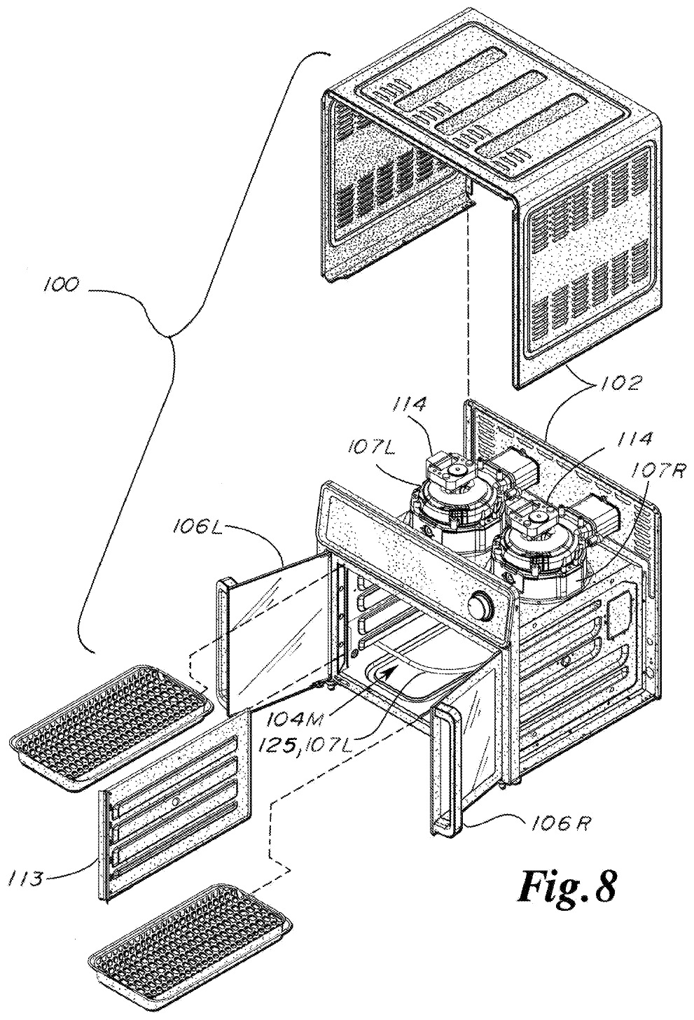

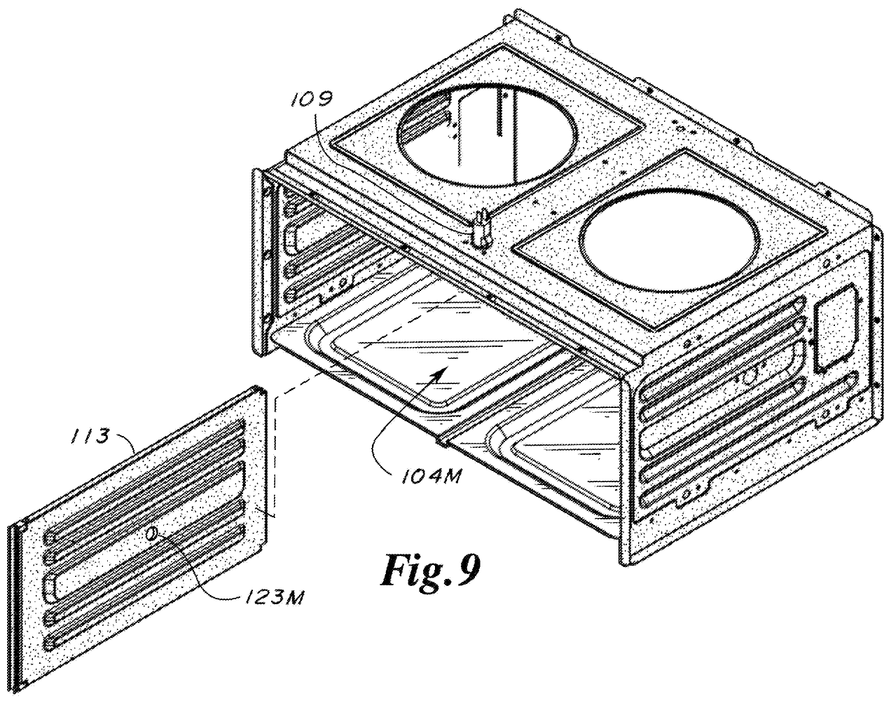

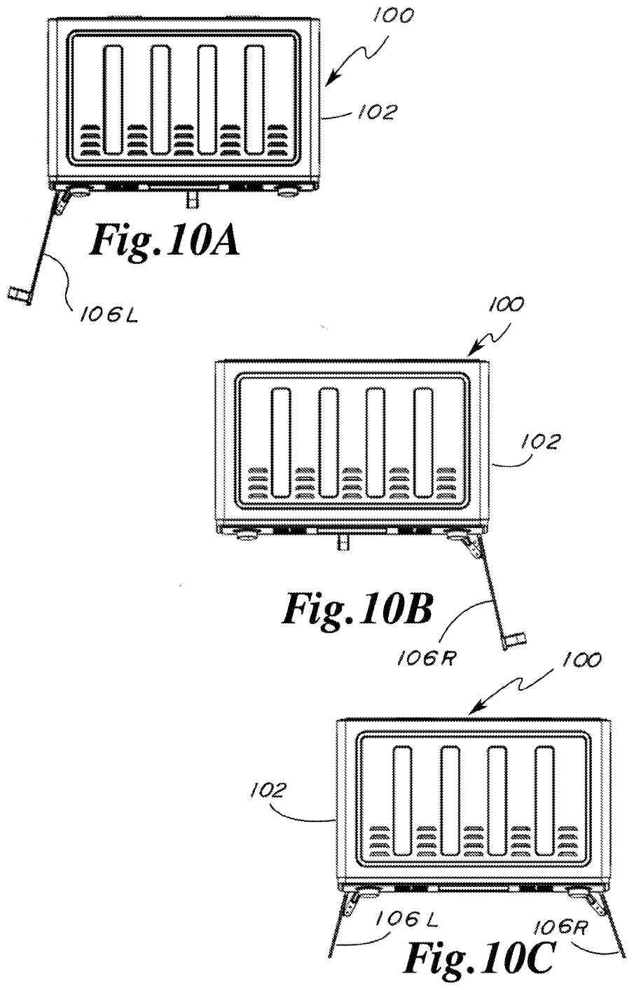

Referring to FIGS. 1 through 10C there is shown a first exemplary cooking appliance, here embodied as electrical countertop fan-forced convection oven 100. A housing 102 defines a primary cooking cavity 104M. Access doors 106L and 106R allow selective access to the cooking cavity. A first electrical cooking element 107L is disposed at the top left side of the cooking cavity. A second electrical cooking element 107R is disposed at the top right side of the cooking cavity.

Each cooking element includes a top electrical air heating element 108, an electric blower (or fan) 114, a bottom electrical heating element 125 and an NTC thermostat 122 (although any equivalent type of thermostat may be substituted). Each blower is arranged to agitate (turbulize) air within the cooking cavity that has been heated by the associate air heating elements or may operate while one or both of the associated heating elements are off to agitate unheated air, such as during a cool-down period.

A separation panel 113 is removably disposable within the primary cooking cavity to divide the primary cooking cavity into left and right secondary cooking cavities 104L and 104R, respectively. The thermostat associated with each of the secondary cooking cavities monitors the temperature there-within. The separation panel fits into the cooking cavity by sliding into grooves 105T and 105B in the top and bottom, respectively, of the cooking cavity atop.

The cooking cavities are equipped with means to receive and rotate a rotisserie (not shown). Those means include receivers 123 on each inner side wall and in the separator panel, receiver 123M in the separator panel, and a motor (not shown) behind the left inner side wall. A longer rotisserie may be inserted when the separator is not present for use in the primary cooking cavity, or a shorter rotisserie may be inserted into just the left cooking cavity for use therein when the separator panel is used. Rotisseries are well known so, for brevity, further description thereof is not felt to be required here.

The insertion of or absence of the separation panel is sensed by microswitch (or sensor) 109. A controller arrangement 118 includes a primary control 108M to operate both cooking elements and the rotisserie (if selected), a left control 108L to operate only the left cooking element, a right control 108R to operate only the right cooking element, an input interface 111, a primary control timer 112M to time the operation of both cooking elements and the rotisserie (if selected) together, a left control timer 112L to time the operation of only the left cooking element, and a right control timer 112R to time the operation of only the right cooking element.

When the microswitch senses the absence of the separation plate and communicates that to the controller arrangement, the primary control, primary control timer, and rotisserie (if selected) are enabled. When the microswitch senses the insertion of the separation plate and communicates that to the controller arrangement, the left and right controls and control timers are enabled.

The input interface is adapted to manually receive cooking parameters for the controls from a user, including such function as cooking temperature, heating element wattages, cooking time, rotisserie operation, etc., and to independently energize the cooking elements according thereto.

During the enablement of the primary controller, both cooking elements and the rotisserie (if selected) are arranged to function equally (synchronized), at the same cooking temperature, heating element wattages, cooking time, etc . . . thereby cooperating as a singular primary cooking element (107R+107L), and the primary controller is arranged to average the temperatures sensed by both thermostats.

During the enablement of the secondary controllers, both cooking elements are arranged to function independently, so that the cooking temperatures, heating element wattages, and cooking times can be set independently of each other to thereby cook two distinct foods differently, one in each secondary cooking cavity and each secondary controller is arranged to cooperate with only its associated thermostat.

The controls may energize the cooking elements in a variety of manners to provide the required cooking parameters. For instance, the heating elements may be cycled on and off to obtain the desired cooking temperature, or the heating element wattages may be continuously varied to obtain the desired cooking temperature, or the blower speed(s) may be varied to obtain the desired level(s) of air turbulence.

The bottom heating elements ensure that the temperature of the air is even from top to bottom throughout the cooking cavities, regardless of whether operation of the secondary or primary cooking cavities.

Countries and regions typically limit the amount of power that an electrical appliance of this type may draw (1800 W in the US), so in this case the wattage consumption of each secondary cooking element is limited to 1800 W when only that secondary cooking element is in use, and the wattage consumption of each secondary cooking element is limited to 900 W when both secondary cooking elements are in use only, thereby limiting the wattage consumption of the primary cooking element to 1800 W.

The left and right access doors allow the user to open only one of the cooking cavities as needed and to thereby avoid any effect on the other.

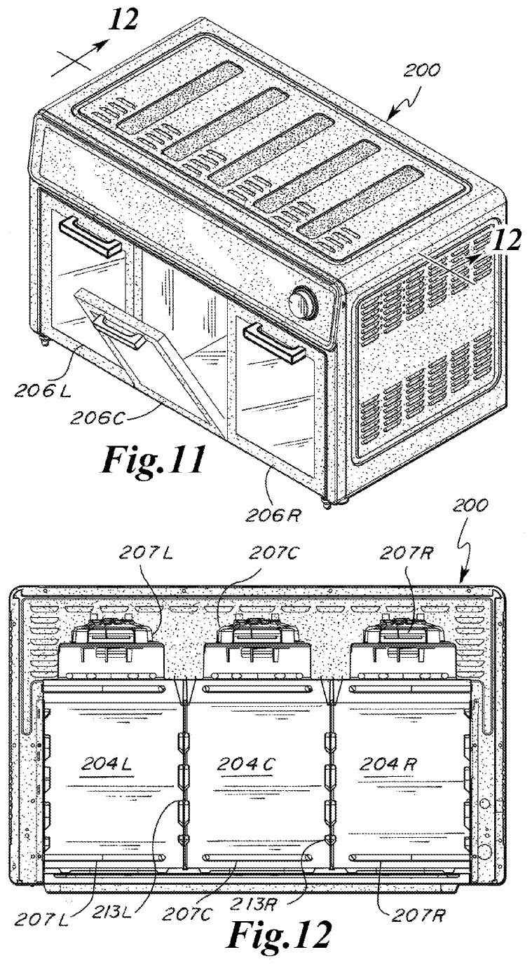

A second exemplary cooking appliance is shown in FIGS. 11 and 12 to demonstrate that the invention can be further practiced with more than two cooking cavities . . . in this case in a similar appliance 200 having three electrical cooking elements 207L, 207C and 207R, three secondary cooking cavities 204L, 204C and 204R, two separator panels 213L and 213R, three downwardly-opening access doors 206L, 206C, and 206R. Construction and function not described follows the teachings of the first embodiment except in accordance with the number of cooking chambers of the particular design . . . undescribed components and functions being obviously increased as appropriate.

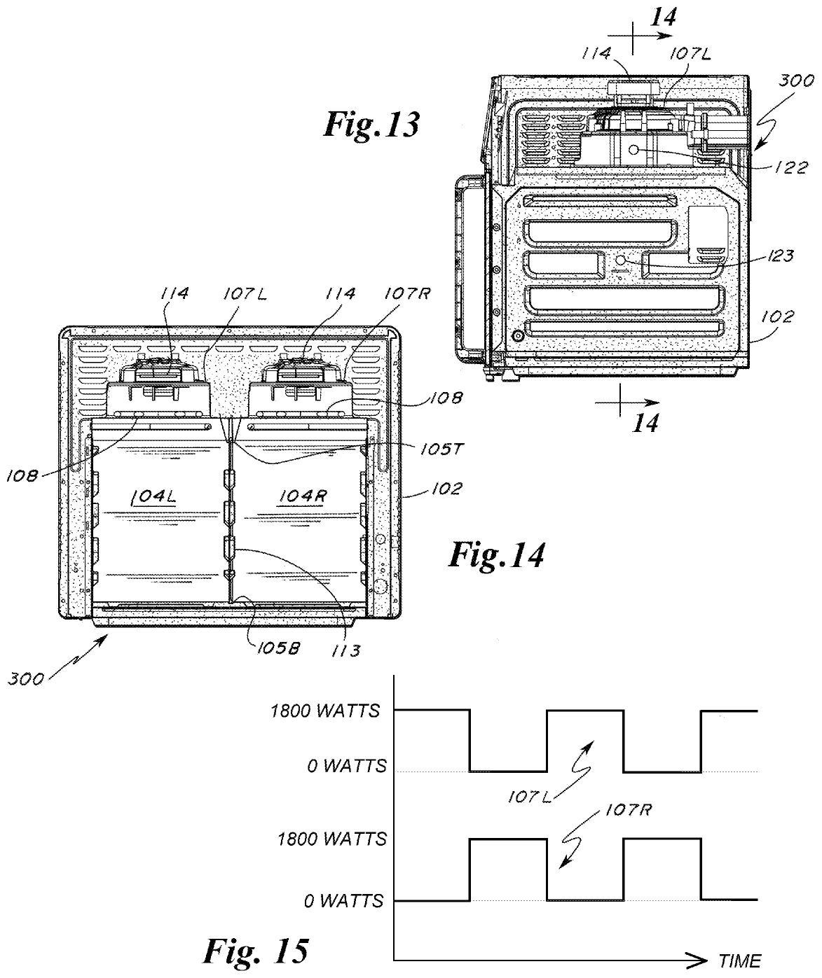

A third exemplary cooking appliance is shown in FIGS. 13 and 14. This embodiment is identical to the first embodiment in all aspects except those that follow.

This embodiment has no lower cooking elements so that the first and second electrical cooking elements 107L and 107R consist only of top electrical air heating elements 108. When used together as a single primary cooking element, the wattage drawn by each will be equal and up to 900 W so that the total wattage drawn by both cannot exceed 1800 W. When separated into ovens and each functioning as an independent secondary cooking element, the wattage drawn by each is limited to 1800 W, but the total wattages drawn by both also cannot exceed 1800 W. So for instance, if one of the elements is drawing 900 W, the other is limited to 900 W, if one of the elements is drawing 1200 W, the other is limited to 600 W, and if one of the elements is drawing 1800 W, the other is disabled.

Alternatively, both heating elements could be cycled so that one's wattage is increased while the other's is decreased as shown on FIG. 15, where one element is operated at 1800 W while the other is 0 W, and then vice-versa, in a continuous cycle. The elements could also be similarly cycled at 1200 W/600 W or at any variation that does not allow both elements to have a total wattage over 1800 W. A particular advantage of this scheme is that it allows higher wattage than usual according to some safety codes which limit continuous wattage consumption to a lower limit than non-continuous. So where a certain heating appliance may be limited to say 1500 W in some jurisdictions if operated continuously, it may be allowed to operate at say 1800 W temporarily, as long as its average wattage over a period of time is below a certain level.

Alternatively, both heating elements 107L and 107R could each be consisting of a pair of independent heating elements, individually selectable, so that user or program can define the optimal wattage allocated to each function or program. While the total power of these heating elements could be above the limit of 1800 W, for example using 2 heating elements of 600 W per side, totaling 2400 W—when used together as a primary cooking elements, an electronic controller could control the total wattage drawn to be equal and up to 1800 W, but the power could be cycled and distributed among the 4 heating portions in a way that maximizes the power used in each cavity, by alternance, in a way to increase the maximum power available in each cavity. For example one cavity could during the first cycle draw 600 W+600 W=1200 W, while the second cavity would only draw 600 W, and in the next cycle, the first cavity would be only drawing 600 W, while the other cavity would this time draw 1200 W. Keeping some power available in the other cavity prevents a full temporary shut-off of the heat distribution during the cycle period in the said cavity, allowing the food to keep cooking more efficiently even when the power levels are limited, and promoting faster cooking times.

While the arrangements shown position the secondary cavities in a horizontal side-by-side arrangement, it is also anticipated that the arrangement could a vertical top-to-bottom one.

And while the arrangements shown include fan-forced convection cooking elements to obtain fan-forced convection cooking, other types of elements/ovens may be substituted without escaping the boundaries of the invention. For instance, the concept could be similarly applied to an oven having radiant or tubular top heating elements without fans to obtain convection-only cooking.

While the invention has been shown and described with reference to specific exemplary embodiments, it should be understood by those skilled in the art that various changes in form and detail may be made without departing from the spirit and scope of the invention, and that the invention should therefore only be limited according to the following claims, including all equivalent interpretation to which they are entitled.

1. A cooking appliance adapted to perform either as a single primary fan-forced convection oven of a first volume capable of cooking foods of a first size, or as two secondary independently-operable fan-forced convection ovens of volumes smaller than the first volume, each only capable of cooking foods of sizes smaller than the first size, and comprising:
a housing defining a primary cooking cavity including two independently-operable cooking elements, one or more access doors, and one user-installable and removable separation panel;
two independently-operable sub-controllers, each associated with one of the independently-operable cooking elements; and
a primary controller associated with both of the independently-operable cooking elements; wherein
the separation panel, when user-installed, is adapted to divide the primary cooking cavity into two separate secondary cooking cavities, each secondary cooking cavity including one of the independently-operable cooking elements and each secondary cooking cavity being accessible through one of the one or more access doors; wherein
the independently-operable cooking elements include a top air heating element disposed within an upper portion of its associated secondary cooking cavity and adapted to heat air within either the primary cooking cavity or its associated one of the secondary cooking cavities, and a fan adapted to turbulize the heated air within the primary cooking cavity or that associated one of the secondary cooking cavities; and
wherein power consumption of the primary cooking element is limited to a maximum wattage, and total power consumption of both independently-operable cooking elements is limited to the maximum wattage.

2. The cooking appliance of claim 1 further comprising a separator panel sensor adapted to sense the presence the user-installed separator panel and adapted to sense the absence of the separator panel.

3. The cooking appliance of claim 2 wherein the sensor is in communication with one or both of the sub-controllers and with the primary controller.

4. The cooking appliance of claim 3 in which each sub-controller controls functions of its associated independently-operable cooking element including one or more of temperature, heating wattage, cooking time, and fan speed.

5. The cooking appliance of claim 4 in which the functions of each independently-operable cooking element may be independently controlled of the functions of the other.

6. The cooking appliance of claim 5 wherein sensing of an absence of the separator panel by the separator panel sensor enables the primary controller to cause the synchronization of the functions of both sub-controllers so that the appliance operates as the single primary fan-forced convection oven employing the primary cooking cavity and both of the independently-operable cooking elements.

7. The cooking appliance of claim 6 wherein the synchronization of the functions of both sub-controllers causes the functions of both of the independently-operable cooking elements equally as a singular primary cooking element.

8. The cooking appliance of claim 9 wherein the functions of the singular primary cooking element include one or more of temperature, heating wattage, cooking time, and fan speed.

9. The cooking appliance of claim 10 wherein the sub-controllers are adapted to limit individual wattage consumption by the independently-operable cooking elements when enabled, and the primary controller is adapted to limit wattage consumption by the primary cooking element when enabled, such that a total wattage consumption does not exceed the maximum wattage consumption.

10. The cooking appliance of claim 9 wherein the maximum wattage consumption is 1800 W.

11. The cooking appliance of claim 10 wherein the one or more access doors are two independently-operable access doors.

12. The cooking appliance of claim 11 wherein each of the independently-operable access doors enables access to only its associated one of the cooking cavities.

13. A cooking appliance adapted to perform either as a primary fan-forced convection oven of a first volume, capable of cooking foods, or as a plurality of secondary independently-operable fan-forced convection ovens of volumes smaller than the first volume, each only capable of cooking foods of sizes smaller than the first size, and comprising:
a housing defining the primary cooking cavity including a plurality of independently-operable cooking elements being equal in number to the plurality of secondary independently-operable fan-forced convection ovens, one or more access doors, and a plurality of user-installable and removable separation panels, being one less in number than the plurality of independently-operable fan-forced convection ovens;
a plurality of independently-operable sub-controllers being equal in number to the plurality of secondary independently-operable fan-forced convection ovens, each associated with one of the plurality of independently-operable cooking elements; and
a primary controller associated with all of the plurality of independently-operable cooking elements;
wherein
each of the plurality of separation panels, when user-installed, is adapted to divide the primary cooking cavity into separate secondary cooking cavities, each secondary cooking cavity including one or more of the independently-operable cooking elements and each secondary cooking cavity being accessible through one of the one or more access doors; wherein
each of the independently-operable cooking elements includes a top air heating element disposed within an upper portion of its associated secondary cooking cavity and adapted to heat air within either the primary cooking cavity or its associated one of the secondary cooking cavities, and a fan adapted to turbulize the heated air within the primary cooking cavity or that associated one of the secondary cooking cavities.
the independently-operable cooking elements include a top air heating element disposed within an upper portion of its associated secondary cooking cavity and adapted to heat air within either the primary cooking cavity or its associated one of the secondary cooking cavities, and a fan adapted to turbulize the heated air within the primary cooking cavity or that associated one of the secondary cooking cavities; and
wherein power consumption of the primary cooking element is limited to a maximum wattage, and total power consumption of both independently-operable cooking elements is limited to the maximum wattage.

14. The cooking appliance of claim 13 further comprising a plurality of separator panel sensors being one less in number than the plurality of independently-operable fan-forced convection ovens, each adapted to sense the presence of an associated one of the user-installed separator panels and adapted to sense the absence of that associated separator panel.

15. The cooking appliance of claim 14 wherein each sensor is in communication with two or more of the sub-controllers and with the primary controller.

16. The cooking appliance of claim 15 in which each sub-controller controls functions of its associated independently-operable cooking element including one or more of temperature, heating wattage, cooking time, and fan speed.

17. The cooking appliance of claim 16 in which the functions of each independently-operable cooking element may be independently controlled of the functions of the others.

18. The cooking appliance of claim 17 wherein sensing of an absence of any of the separator panels by the separator panel sensors enables the primary controller to cause the synchronization of the functions of all sub-controllers so that the appliance operates as the primary fan-forced convection oven employing the primary cooking cavity and all of the independently-operable cooking elements.

19. The cooking appliance of claim 18 wherein the synchronization of the functions of all sub-controllers causes the functions of all of the independently-operable cooking elements equally as a singular primary cooking element.

20. The cooking appliance of claim 19 wherein the functions of the singular primary cooking element include one or more of temperature, heating wattage, cooking time, and fan speed.

21. The cooking appliance of claim 20 wherein the sub-controllers are adapted to limit individual wattage consumption by the independently-operable cooking elements when enabled, and the primary controller is adapted to limit wattage consumption by the primary cooking element when enabled, such that a total wattage consumption does not exceed the maximum wattage consumption.

22. The cooking appliance of claim 21 wherein the maximum wattage consumption is 1800 W.

23. The cooking appliance of claim 22 wherein the one or more access doors are a plurality of independently-operable access doors equal in number to the plurality of secondary independently-operable fan-forced convection ovens.

24. The cooking appliance of claim 23 wherein the number of access doors each of the independently-operable access doors enables access to only its associated one of the cooking cavities.
